(19) United States
(12) Patent Application Publication
(10) Pub. No.: US 2010/0125748 A1
(43) Pub. Date: May 20, 2010

(54) REMOTE DATA ACCESS DEVICE AND REMOTE DATA ACCESS METHOD

(75) Inventors: Chih-Wei CHEN, TAIPEI CITY (TW); Hsiao-Fen LU, TAIPEI CITY (TW)

Correspondence Address: BRIAN M. MCINNIS, 12th Floor, Ruttonjee House, 11 Duddell Street, Hong Kong, HK

(73) Assignee: INVENTEC CORPORATION, TAIPEI CITY (TW)

(21) Appl. No.: 12/357,416

(22) Filed: Jan. 22, 2009

(30) Foreign Application Priority Data
Nov. 20, 2008 (TW) 97144933

(51) Int. Cl. G06F 9/50; G06F 11/20

(52) U.S. Cl. 714/4; 718/104; 714/E11.081

(57) ABSTRACT

A remote data access device and a remote data access method are provided. The remote data access device comprises: a storing module, a first controller and a second controller. The first controller comprises a first odd and a first even access queue. The second controller comprises a second odd and a second even access queue. The first and the second controller have the same MAC and IP addresses. The first and the second odd access queues receive the same odd remote access requests and the first and the second even access queues receive the same even remote access requests, the first controller performs a data access operation on the storing module according to the odd remote access requests in the first odd access queue and the second controller perform a data access operation on the storing module according to the even remote access requests in the second even access queue.

### RELATED APPLICATIONS

This application claims priority to Taiwan Application Serial Number 97144933, filed Nov. 20, 2008, which is herein incorporated by reference.

### BACKGROUND

1. Field of Invention

The present invention relates to a remote data access device. More particularly, the present invention relates to a remote data access device and a remote data access method.

2. Description of Related Art

In a network system, data transfer is the most important subject. The clients in a network system deliver access requests to the server to perform a data access on the storing module of the server. In a conventional design, there are more than two controllers placed in the server. Thus if a controller is fail to work, other controllers can take over. In the network system described above, each controller is in charge of a fixed number of clients. For example, if there are ten clients and two controllers in the network system, one of the controller deals with the access requests of the first half of the clients, and the other controller deals with the access requests of the second half of the clients. However, if the first half of the clients deliver lots of access request while the second half of the clients are idling, the unbalanced loading of the two controllers will result in a bad performance.

Accordingly, what is needed is a remote data access device and a remote data access method to make effective use of the controllers in the server. The present invention addresses such a need.

### SUMMARY

A remote data access device to perform a data access according to a plurality of remote access requests are provided. The remote data access device comprises: a storing module, a first controller and a second controller. The first controller comprises a first odd access queue and a first even access queue and the second controller comprises a second odd access queue and a second even access queue, wherein the first and the second controller has the same MAC and IP addresses such that the first and the second odd access queues receive the same odd remote access requests and the first and the second even access queues receive the same even remote access requests, the first controller performs a data access operation on the storing module according to the odd remote access requests in the first odd access queue and the second controller perform a data access operation on the storing module according to the even remote access requests in the second even access queue.

Another object of the present invention is to provide a remote data access method adapted in a remote data access device, wherein the remote data access device comprises a storing module, a first controller having a first odd access queue and a first even access queue and a second controller having a second odd access queue and a second even access queue, the remote data access method comprises the steps of: assigning the same MAC address to the first and the second controller; assigning the same IP address to the first and the second controller; receiving the odd remote access request into the first odd access queue of the first controller and into the second odd access queue of the second controller; receiving the even remote access request into the first even access queue of the first controller and into the second even access queue of the second controller; performing a data access operation on the storing module according to the odd remote access requests in the first odd access queue through the first controller and the even remote access requests in the second even access queue through the second controller.

Yet another object of the present invention is to provide a remote data access device to perform a data access according to a plurality of remote access requests, wherein the remote data access device comprises: a storing module and N controllers. Each controllers comprises N access queues, wherein each access queue has the same MAC and IP addresses such that the M-th access queue of each controller receive the same M+(A−1)×N remote access requests, the A, M, N are positive integers respectively; the M-th controller performs a data access operation on the storing module according to the M+(A−1)×N remote access requests in the M-th access queue.

Further, another object of the present invention is to provide a remote data access method adapted in a remote data access device, wherein the remote data access device comprises a storing module and N controllers each having N access queues, N is an integer, wherein the remote data access method comprises the steps of: assigning the same MAC address to the N controllers; assigning the same IP address to the N controllers; receiving the M+(A−1)×N remote access request into the M-th access queue of each controller; and performing a data access operation on the storing module according to the M+(A−1)×N remote access requests in the M-th access queue through the M-th controller.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a diagram of the remote data access device of the first embodiment of the present invention;

FIG. 2A is a diagram of the remote data access device when the first controller malfunctions;

FIG. 2B is a diagram of the remote data access device when the second controller malfunctions;

FIG. 3 is a diagram of the remote data access device in another embodiment of the present invention;

FIG. 4 is a flow chart of the remote data access method of an embodiment of the present invention; and

FIG. 5 is a flow chart of remote data access method of yet another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

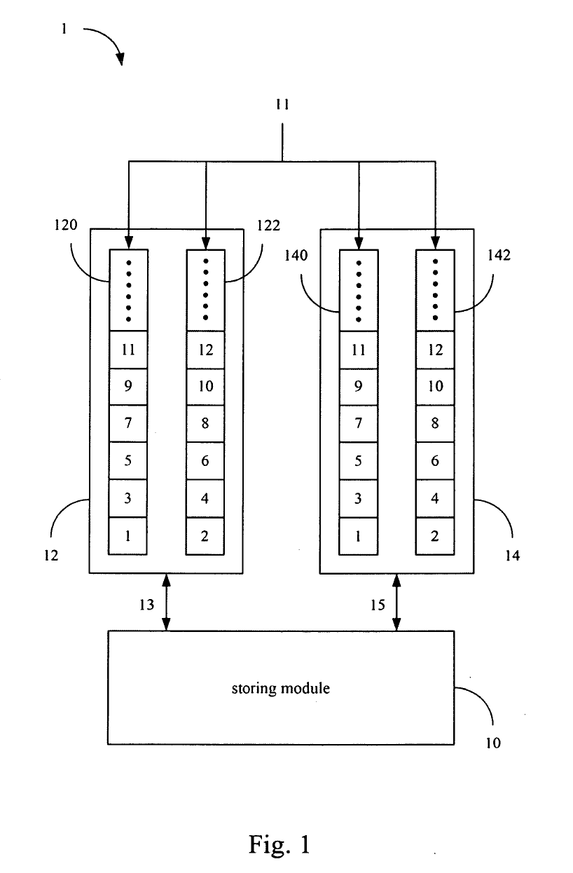

Please refer to FIG. 1, a diagram of the remote data access device 1 of the first embodiment of the present invention. The remote data access device 1 comprises: a storing module 10, a first controller 12 and a second controller 14. The storing module 10 of the present embodiment comprises a plurality of hard drives (not shown). The data is stored in or retrieved from the hard drives to accomplish the data access. The first controller 12 and the second controller 14 are to receive remote access requests 11 from the other servers or clients (not shown) and further perform data access operation on the storing module 10 according to the remote access requests 11. The remote access requests 11 are transferred through a packet format. The remote access requests 11 can be distinguished as odd remote access requests such as the 1st, 3rd, 5th, . . . , 2m−1 th remote access requests and even remote access requests such as the 2nd, 4th, 6th, 2m th remote access requests, wherein m is a positive integer. The first controller 12 comprises a first odd access queue 120 and a first even access queue 122. The second controller 14 comprises a second odd access queue 140 and a second even access queue 142. The first and the second controller are an internet small computer system interface (iSCSI) respectively. In other embodiment, different interfaces can be adapted as well. The first and the second controller 12, 14 has the same MAC and IP addresses such that the first and the second odd access queues 120, 140 receive the same odd remote access requests, such as 1st, 3rd, 5th, . . . , 2m−1 th remote access requests described above and the first and the second even access queues 122, 142 receive the same even remote access requests, such as the 2nd, 4th, 6th, 2m th remote access requests described above. The first controller 12 performs a data access operation 13 on the storing module 10 according to the odd remote access requests in the first odd access queue 120, and the second controller 14 perform a data access operation 15 on the storing module 10 according to the even remote access requests in the second even access queue 142.

The remote data access device of the present embodiment is to assign the same IP and MAC addresses to the first and the second controller 12, 14 to receive the same remote access requests. However, the different controllers deal with half of the remote access requests respectively. Thus, the loading of the data access is equally shared by the two controllers.

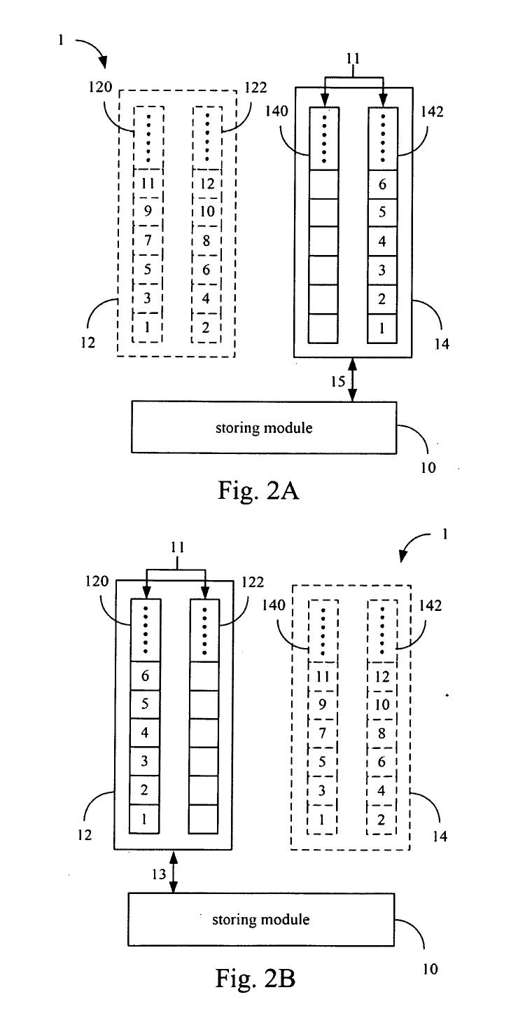

If the first controller 12 malfunctions, the second even access queue 142 of the second controller 14 receives both the odd and the even remote access requests and perform a data access operation 15 on the storing module 10 according to the odd and the even remote access requests in the second even access queue 142, as depicted in FIG. 2A, which is a diagram of the remote data access device 1 when the first controller 12 malfunctions. When the first controller 12 malfunctions and the first odd access queue 120 comprises at least one unprocessed odd remote access request, the second even access queue 142 of the second controller 14 receives the unprocessed odd remote access request again to perform the data access on the storing module 10 according to the unprocessed odd remote access request. Further, if the first controller 12 recovers from the malfunction, the first odd and the first even access queue 120, 122 are cleaned before the first controller 12 starts to receive the new remote access requests 11. On the other side, when the second controller 14 malfunctions, the first odd access queue 120 of first controller 12 receives both the odd and the even remote access requests and perform a data access operation 13 on the storing module 10 according to the odd and the even remote access requests in the first odd access queue 120. When the second controller 14 malfunctions and the second even access queue 142 comprises at least one unprocessed even remote access request, the first odd access queue 120 of the first controller 12 receives the at least one unprocessed even remote access request again to perform a data access on the storing module 10 according to the at least one unprocessed odd remote access request. Further, if the second controller 14 recovers from the malfunction, the second odd and the second even access queue 140, 142 are cleaned before the second controller 14 starts to receive the new remote access requests 11.

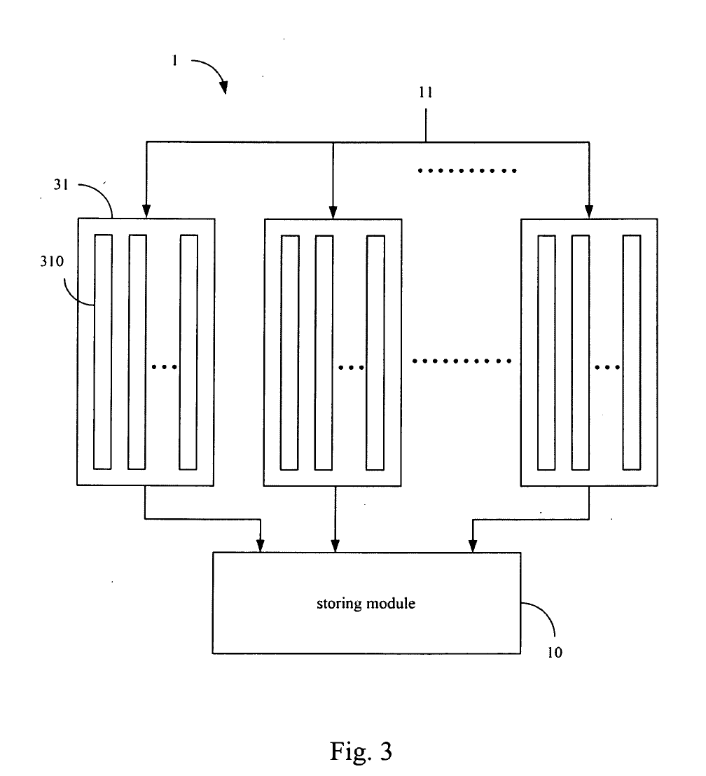

Please refer to FIG. 3, a diagram of the remote data access device 3 in another embodiment of the present invention. The remote data access device 3 comprises a storing module 30 and N controllers 31. Each controllers 31 comprises N access queues 310, wherein each access queue 310 has the same MAC and IP addresses such that the M-th access queue of each controller 31 receive the same M+(A−1)×N remote access requests, the A, M, N are positive integers respectively. The M-th controller performs a data access operation on the storing module 30 according to the M+(A−1)×N remote access requests in the M-th access queue. For example, if the remote data access device 3 comprises five controllers 31 each having five access queues 310, after assigning each controllers the same IP and MAC addresses, the second access queue of each controllers 31 receives the 2nd, 7th, 12th, 17th . . . access requests, and the second controller will perform the data access according to the 2nd, 7th, 12th, 17th . . . access requests in the second access queue.

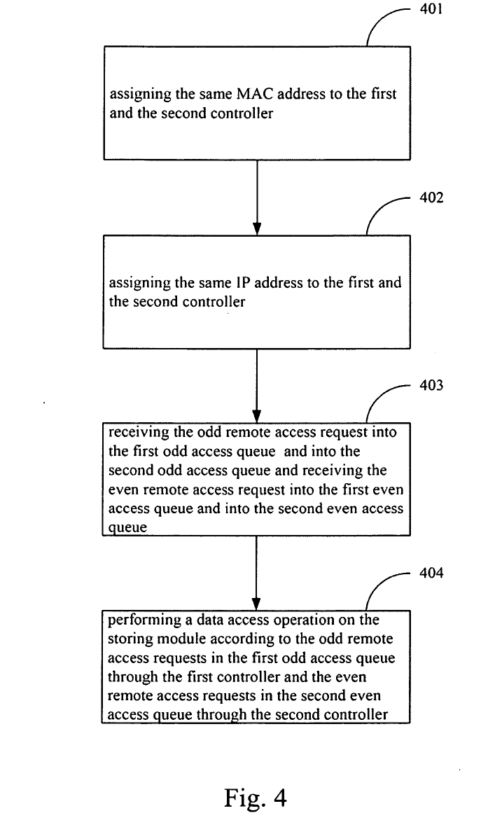

Another object of the present invention is to provide a remote data access method adapted in a remote data access device, wherein the remote data access device comprises a storing module, a first controller having a first odd access queue and a first even access queue and a second controller having a second odd access queue and a second even access queue. Please refer to FIG. 4, a flow chart of the remote data access method of an embodiment of the present invention. The remote data access method comprises the steps of: in step 401, assigning the same MAC address to the first and the second controller; in step 402, assigning the same IP address to the first and the second controller; in step 403, receiving the odd remote access request into the first odd access queue of the first controller and into the second odd access queue of the second controller and receiving the even remote access request into the first even access queue of the first controller and into the second even access queue of the second controller; in step 404, performing a data access operation on the storing module according to the odd remote access requests in the first odd access queue through the first controller and the even remote access requests in the second even access queue through the second controller.

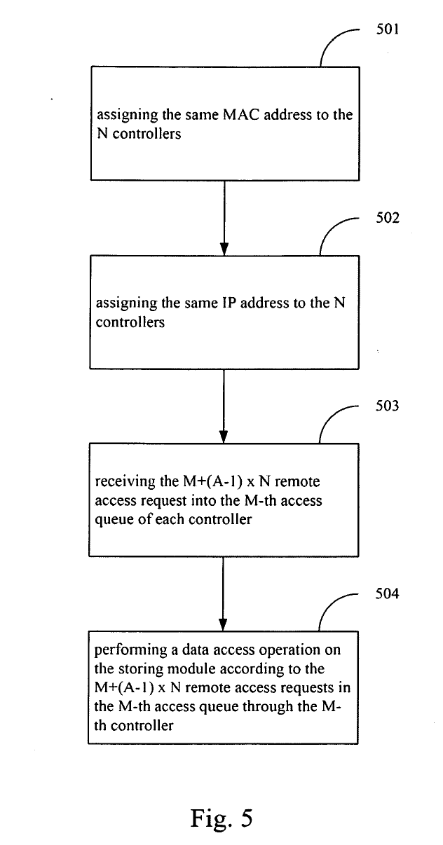

Yet another embodiment of the present invention is a remote data access method adapted in a remote data access device, wherein the remote data access device comprises a storing module and N controllers each having N access queues, N is an integer. As depicted in FIG. 5, a flow chart of remote data access method of yet another embodiment of the present invention. The remote data access method comprises the steps of: in step 501, assigning the same MAC address to the N controllers; in step 502, assigning the same IP address to the N controllers; in step 503, receiving the M+(A−1)×N remote access request into the M-th access queue of each controller; and in step 504, performing a data access operation on the storing module according to the M+(A−1)×N remote access requests in the M-th access queue through the M-th controller.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A remote data access device to perform a data access according to a plurality of remote access requests, wherein the remote data access device comprises:
a storing module;
a first controller comprising a first odd access queue and a first even access queue; and
a second controller comprising a second odd access queue and a second even access queue, wherein the first and the second controller has the same MAC and IP addresses such that the first and the second odd access queues receive the same odd remote access requests and the first and the second even access queues receive the same even remote access requests, the first controller performs a data access operation on the storing module according to the odd remote access requests in the first odd access queue and the second controller perform a data access operation on the storing module according to the even remote access requests in the second even access queue.

2. The remote data access device of claim 1, wherein each of the odd and the even remote access requests are transferred through a packet format.

3. The remote data access device of claim 1, wherein the first and the second controller are an internet small computer system interface (iSCSI) respectively.

4. The remote data access device of claim 1, when the first controller malfunctions, the second even access queue of the second controller receives both the odd and the even remote access requests and perform a data access operation on the storing module according to the odd and the even remote access requests in the second even access queue.

5. The remote data access device of claim 4, when the first controller malfunctions and the first odd access queue comprises at least one unprocessed odd remote access request, the second even access queue of the second controller receives the at least one unprocessed odd remote access request again to perform a data access on the storing module according to the at least one unprocessed odd remote access request.

6. The remote data access device of claim 4, the first odd and the first even access queue are cleaned before the first controller recovers from the malfunction.

7. The remote data access device of claim 1, when the second controller malfunctions, the first odd access queue of first controller receives both the odd and the even remote access requests and perform a data access operation on the storing module according to the odd and the even remote access requests in the first odd access queue.

8. The remote data access device of claim 7, when the second controller malfunctions and the second even access queue comprises at least one unprocessed even remote access request, the first odd access queue of the first controller receives the at least one unprocessed even remote access request again to perform a data access on the storing module according to the at least one unprocessed odd remote access request.

9. The remote data access device of claim 7, the second odd and the second even access queue are cleaned before the second controller recovers from the malfunction.

10. A remote data access method adapted in a remote data access device, wherein the remote data access device comprises a storing module, a first controller having a first odd access queue and a first even access queue and a second controller having a second odd access queue and a second even access queue, the remote data access method comprises the steps of:
assigning the same MAC address to the first and the second controller;
assigning the same IP address to the first and the second controller;
receiving the odd remote access request into the first odd access queue of the first controller and into the second odd access queue of the second controller;
receiving the even remote access request into the first even access queue of the first controller and into the second even access queue of the second controller;
performing a data access operation on the storing module according to the odd remote access requests in the first odd access queue through the first controller and the even remote access requests in the second even access queue through the second controller.

11. The remote data access method of claim 10, wherein each of the odd and the even remote access requests are transferred through a packet format.

12. The remote data access method of claim 10, wherein the first and the second controller are an internet small computer system interface (iSCSI) respectively.

13. The remote data access method of claim 10, when the first controller malfunctions, the second even access queue of the second controller receives both the odd and the even remote access requests and perform a data access operation on the storing module according to the odd and the even remote access requests in the second even access queue.

14. The remote data access method of claim 13, when the first controller malfunctions and the first odd access queue comprises at least one unprocessed odd remote access request, the second even access queue of the second controller receives the at least one unprocessed odd remote access request again to perform a data access on the storing module according to the at least one unprocessed odd remote access request.

15. The remote data access method of claim 13, the first odd and the first even access queue are cleaned before the first controller recovers from the malfunction.

16. The remote data access method of claim 10, when the second controller malfunctions, the first odd access queue of first controller receives both the odd and the even remote access requests and perform a data access operation on the storing module according to the odd and the even remote access requests in the first odd access queue.

17. The remote data access method of claim 16, when the second controller malfunctions and the second even access queue comprises at least one unprocessed even remote access request, the first odd access queue of the first controller receives the at least one unprocessed even remote access request again to perform a data access on the storing module according to the at least one unprocessed odd remote access request.

18. The remote data access method of claim 17, the second odd and the second even access queue are cleaned before the second controller recovers from the malfunction.

19. A remote data access device to perform a data access according to a plurality of remote access requests, wherein the remote data access device comprises:
a storing module; and
N controllers each comprising N access queues, wherein each access queue has the same MAC and IP addresses such that the M-th access queue of each controller receive the same M+(A−1)×N remote access requests, the A, M, N are positive integers respectively;
the M-th controller performs a data access operation on the storing module according to the M+(A−1)×N remote access requests in the M-th access queue.

20. A remote data access method adapted in a remote data access device, wherein the remote data access device comprises a storing module and N controllers each having N access queues, N is an integer, wherein the remote data access method comprises the steps of:
assigning the same MAC address to the N controllers;
assigning the same IP address to the N controllers;
receiving the M+(A−1)×N remote access request into the M-th access queue of each controller; and
performing a data access operation on the storing module according to the M+(A−1)×N remote access requests in the M-th access queue through the M-th controller.
